(19) United States
(12) Patent Application Publication
(10) Pub. No.: US 2008/0005234 A1
(43) Pub. Date: Jan. 3, 2008

(54) Providing Discussion Thread Context for Posts Displayed in a Flat List

(75) Inventors: Jennifer L. Newnam Giardino, Wake Forest, NC (US); Alexander Kordun, Arlington, MA (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/427,788

(22) Filed: Jun. 30, 2006

(51) Int. Cl. G06F 15/16

(52) U.S. Cl. 709/204

(57) ABSTRACT

A method of providing contextual information in a discussion forum can include presenting a flat view of a plurality of posts of a discussion thread and providing a control proximate to at least one of the plurality of posts, wherein each control is associated with the post proximate to that control. Responsive to activation of a control associated with a selected post, presenting hierarchy information relating to the discussion thread concurrently with the flat view. A context for the flat view can be maintained.

### BACKGROUND

1. Field of the Invention

The present invention relates to online discussion forums and, more particularly, to user interfaces for the presentation of discussion forum information.

2. Description of the Related Art

An online discussion forum (discussion forum) refers to a virtual meeting place such as a Web page, whether available through a public network, such as the Internet, or a private network, such as an intranet. Within that virtual meeting place, users post messages (posts). Other names for discussion forums can include, but are not limited to, Web forums, message boards, discussion boards, discussion groups, and bulletin boards. In general, users can upload posts to the discussion forum. These posts can be viewed by other users who may respond, in turn, by uploading response posts to the discussion forum. A sequence of posts, beginning with a first post and including all other posts uploaded in response to that initial, or root, post, is referred to as a discussion thread. Users need not be online at the same time to participate in a discussion forum.

Typically, users can view and sort posts according to metadata attributes of the posts such as the timestamp which indicates when each post was uploaded, the author of each post, or the like. A common way of displaying posts, for example, is simply by listing the posts of a given discussion thread according to timestamp. This type of view, often referred to as a list view or a flat view, presents the user with a chronologically sorted list of posts for a given discussion thread. A list or flat view is characterized by the fact that thread hierarchy information is available in the view.

Another way of displaying posts is to present posts of a discussion thread in a tree view. A tree view, as opposed to a flat view, can indicate hierarchy information for the discussion thread. Hierarchy information effectively indicates which post is the root post of the discussion thread, and further indicates parent-child, or post-reply, relationships among the various posts of the discussion thread. A tree view clearly indicates the particular post for which another post was uploaded as a response.

When creating a post and contributing to a discussion thread, a user must first locate the particular post to which the response post is directed. Frequently, this is performed using the flat view of the discussion thread as different filtering functions are provided within flat views, such as sorting by name, time stamp, etc. The flat view, however, provides no information relating to the hierarchy of the discussion thread. The location of the post to which the user is responding within the discussion thread hierarchy is not shown. Hierarchy information may be highly relevant to crafting a reply and, therefore, desired by the user. For the user to review the hierarchy, it becomes necessary to switch to a tree view or an indented view. Once the new view is displayed, the user must then relocate the post of interest as the context of the prior flat view is lost.

In the course of interacting with others in a discussion forum, using a variety of different views is often necessary, particularly as each view is suited to providing a selected set of features. Switching from one view to another to utilize these features, however, also means that context is lost and the user must relocate posts of interest. It would be beneficial to provide a mechanism for visualizing discussion forum information in a manner which addresses the limitations described above.

### SUMMARY OF THE INVENTION

The present invention provides method(s) and apparatus relating to user interfaces for use with online discussion forums. One embodiment of the present invention can include a method of providing context information in a discussion forum. The method can include presenting a flat view of a plurality of posts of a discussion thread and providing a control proximate to at least one of the plurality of posts, wherein each control is associated with the post proximate to that control. Responsive to activation of a control associated with a selected post, hierarchy information relating to the discussion thread can be presented concurrently with the flat view. A context for the flat view can be maintained.

Another embodiment of the present invention can include a method of providing context information in a discussion forum including presenting a list of posts of a discussion thread, where the posts are organized according to a parameter unrelated to discussion thread hierarchy. A control can be provided proximate to at least one of the posts. Each control can be associated with the post proximate to that control. Responsive to selection of a control associated with a selected post, indicators for the selected post and at least one other post that belongs to the same discussion thread as the selected post can be displayed within a distinct view. The distinct view can be displayed concurrently with the list of posts.

Yet another embodiment of the present invention can include a machine readable storage being programmed to cause a machine to perform the various steps and/or functions described herein.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 depicts a view of a conventional graphical user interface (GUI) for use with a discussion forum.

FIG. 2 depicts a view for use with a discussion forum in accordance with one embodiment of the present invention.

FIG. 3 depicts a view of a post from FIG. 2 in accordance with another embodiment of the present invention.

FIG. 4 depicts a view of a post from FIG. 2 in accordance with another embodiment of the present invention.

FIG. 5 depicts a view of a post from FIG. 2 in accordance with another embodiment of the present invention.

FIG. 6 is a view of a window after selection of an indicator in accordance with another embodiment of the present invention.

FIG. 7 is a view of a window after selecting an indicator in accordance with another embodiment of the present invention.

FIG. 8 is a flow chart illustrating a method of presenting information for use in a discussion forum in accordance with yet another embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

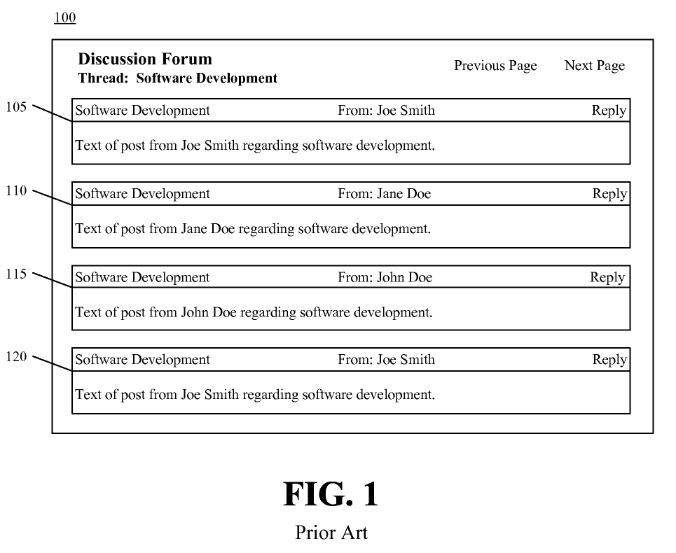

FIG. 1 depicts a view 100 of a conventional graphical user interface (GUI) for use with a discussion forum. The view 100 can be rendered within a browser or other application. For example, the browser can navigate to a particular markup language document, which when loaded and executed within the browser, causes view 100 to be rendered. In any case, the view 100 is presenting a list, or flat, view of a plurality of posts 105, 110, 115, and 120 of a particular discussion thread relating to “software development”. The view 100 lists the posts in a selected order, for example by time stamp, though the respective time of each post is not shown. Within a flat view, one cannot visually discern the hierarchy of the discussion thread. That is, for instance, the view 100 does not indicate whether post 120 was a response to post 105, 110, or 115.

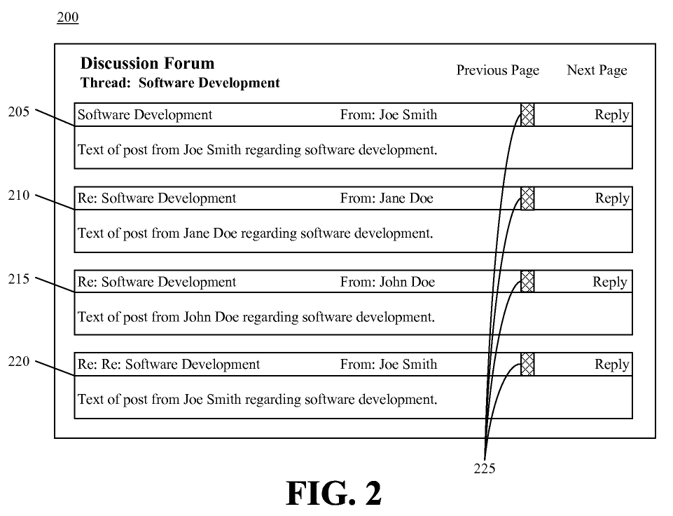

FIG. 2 depicts a view 200 for use with a discussion forum in accordance with one embodiment of the present invention. The view 200 can be similar to that illustrated with reference to FIG. 1 with the exception that additional controls have been added. As shown, each post 205, 210, 215, and 220 of the view 200 now includes a control 225. The control 225, when activated, can cause additional information to be provide which relates to the hierarchy of the discussion thread in which the associated post is located. This information can be presented within a window that is presented, or drawn, over the existing view 200. Accordingly, the user is not forced to switch views and lose context to find additional hierarchical information pertaining to a selected post.

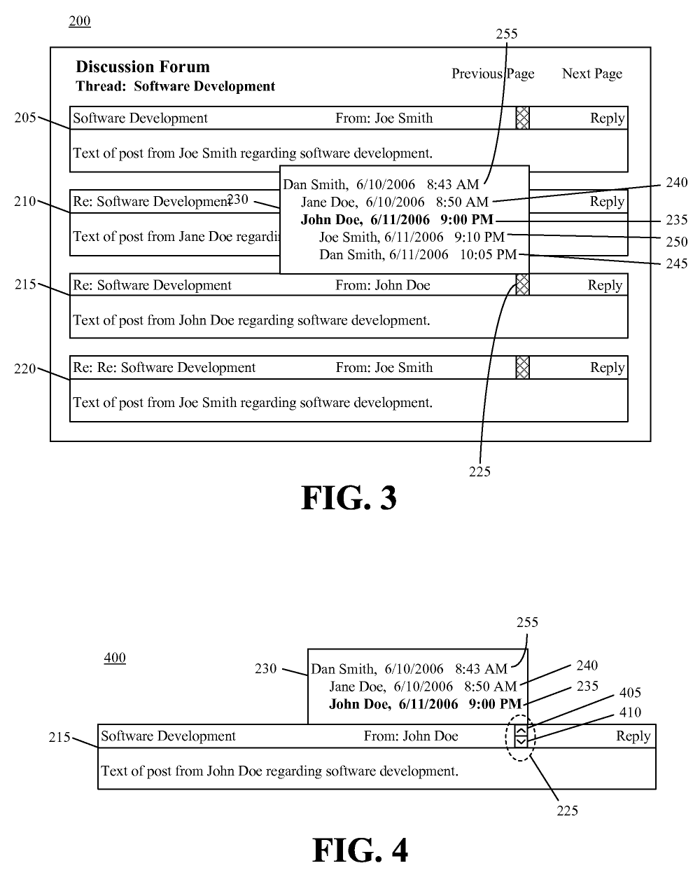

FIG. 3 depicts a view 200 for use with a discussion forum in accordance with one embodiment of the present invention. As shown, control 225 of post 215 has been selected or activated. Responsive to that selection, window 230 has been displayed. Within window 230, a portion of the discussion thread, i.e. a sub-thread, can be displayed. The sub-thread can include an indicator 235 corresponding to the selected post 215.

The window 230 can include a hierarchical view relating to post 215. The hierarchical view provides hierarchical information pertaining to post 215, which is displayed concurrently with the flat view of the posts 205, 210, 215, and 220. More particularly, the information included within window 230 visually indicates the location of post 215 within the hierarchy of the discussion thread with which post 215 is associated. In this case, within window 230, the indicator 235 representing post 215 is shown in bold. Other posts of the discussion thread, which may or may not be visible in view 200, are represented within the hierarchy with indicators 240, 245, 250, and 255. Each indicator is visually ordered to indicate the hierarchy of the discussion thread, i.e. the location of each post within the hierarchy. Thus, indicator 235, representing post 215, and indicator 240, which represents a sibling post of post 215, are in response to a parent post represented by indicator 255. Child posts of post 215, i.e. posts made in response to post 215, are represented by indicator 245 and 250.

While the indicator can be presented in an indented view, as shown, in another embodiment, the identifiers can be presented in a tree view with expandable branches. Accordingly, levels of the hierarchy with more than one post may be represented as an expandable branch to simplify the view presented within window 230. For example, indicators 245 and 250 can be collapsed beneath indicator 235.

In one embodiment, a limited number of post indicators can be presented within window 230, i.e. a predetermined number of indicators above and/or below the indicator 235 within the discussion thread hierarchy can be shown. In another embodiment, the entire thread can be presented within window 230. Window 230 can be sized to fit the post indicators of the discussion thread and/or scroll buttons can be provided which allow the user to navigate the hierarchy of the discussion thread if the hierarchy is too large to fit within window 230.

In another embodiment of the present invention, selection of one of the indicators can cause the post represented by the selected indicator to be displayed within the window 230. This can be the case with the exception of the selected post, i.e. post 215, since that post continues to be displayed in the flat view. Context of the flat view is preserved in that the flat view does not change as window 230 is presented. Thus, selection of indicator 235 will not cause any action, whereas selection of indicator 255 will cause the parent post corresponding to identifier 255 to be displayed within window 230.

FIG. 4 depicts a view 400 of post 215 of FIG. 2 in accordance with another embodiment of the present invention. In this case, the control 225 has been implemented with two portions 405 and 410. As shown, control portion 405 has been activated. Activation of control portion 405 presents window 230 including hierarchical discussion thread information for post 215. In this case, however, the information is limited, or filtered, such that only the indicator 235 corresponding to post 215 and indicators for posts at the same level or above post 215 in terms of the discussion thread hierarchy are displayed. Accordingly, indicators 240, representing a sibling post, and 255, representing a parent (or root) post, have been displayed.

In one embodiment, only a particular number of identifiers corresponding to posts above the selected post in the discussion thread hierarchy are displayed. In another embodiment, indicators for all posts beginning with the root post and continuing to the selected post, i.e. post 215, can be displayed. If need be, scroll controls can be provided in window 230 to allow the user to view all of the hierarchy information provided.

In another embodiment, indicators for sibling posts can be excluded from presentation within window 230. In that case, the indicator 240 corresponding to the sibling post of post 215, would not be displayed. This would allow window 230 to present only indicators for parent posts and no siblings if so desired. As was the case with reference to FIG. 3, selection of an indicator, with the exception of indicator 235 can cause the post associated with the selected indicator to be displayed within window 230, thereby allowing the user to jump to different posts within the discussion thread hierarchy without leaving the current flat view.

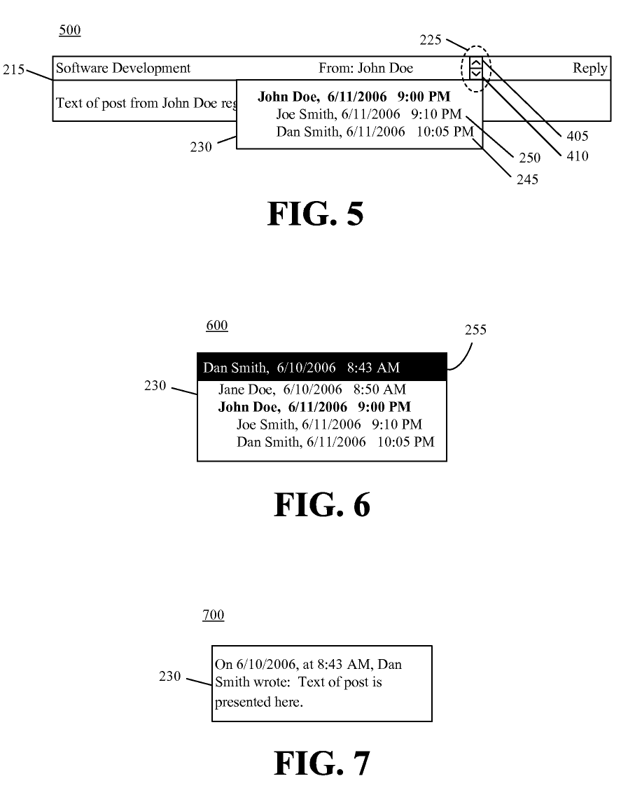

FIG. 5 depicts a view 500 of post 215 of FIG. 2 in accordance with another embodiment of the present invention. The control 225 has been implemented with two portions 405 and 410. As shown, control portion 410 has been activated. Activation of control portion 410 presents window 230 including hierarchical discussion thread information for post 215. In this case, the information is limited, or filtered, such that only the indicator 235 corresponding to post 215 and indicators for posts at the same level or below post 215 in terms of the discussion thread hierarchy are displayed. Accordingly, indicators 240, representing a sibling post, and 245 and 250, representing a child posts, have been displayed.

In one embodiment, only a particular number of indicators corresponding to posts below the selected post in the discussion thread hierarchy are displayed. In another embodiment, indicators for all posts beginning with the selected post 215 and continuing to the end of the hierarchy including all child posts, i.e. posts corresponding to identifiers 245 and 250, can be displayed. If need be, scroll controls can be provided in window 230 to allow the user to view all of the hierarchy information provided.

In this embodiment, indicators for sibling posts of post 215 have been excluded. It should be appreciated that in another embodiment, indicators for sibling posts of the selected post 215 can be included if so desired. As noted, selection of an indicator, with the exception of indicator 235 can cause the post associated with the selected indicator to be displayed within window 230, thereby allowing the user to jump to different posts within the discussion thread hierarchy without leaving the current flat view.

FIG. 6 is a view 600 of the window 230 after selection of indicator 255 in accordance with another embodiment of the present invention. As shown, a user has selected indicator 255 to display the post associated with indicator 255.

FIG. 7 is a view 700 of a window after the selection of an indicator in accordance with another embodiment of the present invention. More particularly, view window 230 displays the post associated with indicator 255 responsive to the selection of that indicator as illustrated in FIG. 6. It should be appreciated that further controls such as a “back” control (not shown) can be provided within window 230 which would allow the user to navigate back to the view presented in window 230 in FIG. 6 if so desired.

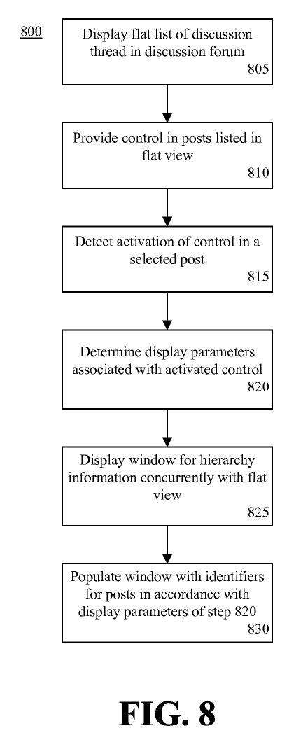

FIG. 8 is a flow chart illustrating a method 800 of presenting information for use in a discussion forum in accordance with yet another embodiment of the present invention. The method 800 can begin in step 805 where a plurality of posts of a discussion thread are displayed within a flat or list view. As noted, a flat or list view is one which does not provide information pertaining to the hierarchy of the discussion thread with which the post(s) are associated.

In step 810, a control can be provided for one or more, or each, of the posts displayed. In step 815, activation of a control for a selected post displayed in the flat view can be detected. In step 820, one or more display parameters associated with the selected control can be determined. Such parameters can regulate which indicators for posts within the discussion thread of the selected post are to be displayed within a hierarchy view. As noted, the displayed indicators can correspond to parent posts, child posts, sibling posts, and any combination thereof, depending upon the implementation of the control and which portion of the control is activated, if the control is subdivided into a plurality of selectable portions.

In step 825, responsive to activation of the control, a window for displaying hierarchy information can be presented. As noted, this window can be presented, or displayed, concurrently with the flat view. In step 830, the window can be populated with identifiers corresponding to attributes identified in step 820. Thus, identifiers for one or more or all posts can be displayed and/or filtered, as the case may be, in accordance with the attributes. The display of identifiers can be visually organized to indicate hierarchy, i.e. as a tree view with expandable branches, or as an indented view where each branch is fully expanded. The context of the underlying list view can remain unchanged.

The embodiments disclosed herein allow a user to remain within a current, hierarchy-deficient view and simultaneously display the hierarchy relating to a particular post within a discussion thread. Further, the user can jump to any post in the hierarchy while not leaving that “flat” view. In this manner, the user maintains the full context of the selected post without losing functionality of the current view, while also gaining the ability to view and navigate a discussion thread hierarchy. It should be appreciated that the various user interfaces illustrated herein have been provided for purpose of illustration only. As such, various aspects of the interfaces can be modified without departing from the scope of the present invention.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein. The present invention also can be embedded in a computer program product, which comprises all the features enabling the implementation of the methods described herein, and which when loaded in a computer system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, a computer program can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an”, as used herein, are defined as one or more than one. The term “plurality”, as used herein, is defined as two or more than two. The term “another”, as used herein, is defined as at least a second or more. The terms “including” and/or “having”, as used herein, are defined as comprising, i.e. open language.

This invention can be embodied in other forms without departing from the spirit or essential attributes thereof. Accordingly, reference should be made to the following claims, rather than to the foregoing specification, as indicating the scope of the invention.

What is claimed is:

1. A method of providing context information in a discussion forum comprising:
presenting a flat view comprising a plurality of posts of a discussion thread;
providing a control proximate to at least one of the plurality of posts, wherein each control is associated with the post proximate to that control; and
responsive to activation of a control associated with a selected post, presenting hierarchy information relating to the discussion thread concurrently with the flat view, wherein context of the flat view is maintained.

2. The method of claim 1, wherein presenting hierarchy information further comprises displaying a portion of the discussion thread comprising the selected post, wherein a location of the selected post within a hierarchy of the discussion thread is indicated.

3. The method of claim 2, further comprising responsive to a selection of a post indicator within the portion of the discussion thread, presenting a post represented by the selected post indicator.

4. The method of claim 1, wherein presenting hierarchy information further comprises displaying indicators for the selected post, at least one parent post of the selected post, and at least one child post of the selected post, wherein each indicator is visually organized according to a hierarchy of the discussion thread.

5. The method of claim 1, wherein the control comprises at least a first section and a second section and the first section of the control is activated, wherein presenting hierarchy information further comprises displaying indicators for the selected post and only posts above the selected post according to a hierarchy of the discussion thread, wherein each indicator displayed is visually organized according to the hierarchy of the discussion thread.

6. The method of claim 5, further comprising displaying an indicator for a sibling post of the selected post, wherein the indicator for the sibling post is visually organized according to the hierarchy of the discussion thread.

7. The method of claim 5, further comprising locating the hierarchical view above the activated control.

8. The method of claim 1, wherein the control comprises at least a first section and a second section and the second section of the control is activated, wherein presenting a hierarchical view further comprises displaying indicators for the selected post and only posts below the selected post according to a hierarchy of the discussion thread, wherein each indicator displayed is visually organized according to the hierarchy of the discussion thread.

9. The method of claim 8, further comprising displaying an indicator for a sibling post of the selected post, wherein the indicator for the sibling post is visually organized according to the hierarchy of the discussion thread.

10. The method of claim 8, further comprising locating the hierarchical view below the activated control.

11. A method of providing context information in a discussion forum comprising:
presenting a list of posts of a discussion thread, wherein the posts are organized according to a parameter unrelated to discussion thread hierarchy;
providing a control proximate to at least one of the posts, wherein each control is associated with the post proximate to that control; and
responsive to selection of a control associated with a selected post, displaying within a distinct view, concurrently with the list of posts, hierarchy information comprising indicators for the selected post and at least one other post that belongs to the same discussion thread as the selected post.

12. The method of claim 10, wherein displaying further comprises visually organizing the indicators for the selected post and the at least one other post according to a hierarchy of the discussion thread.

13. The method of claim 10, wherein displaying further comprises displaying only indicators for the selected post and at least one child post of the selected post.

14. The method of claim 10, wherein displaying further comprises displaying only indicators for the selected post and at least one parent post of the selected post.

15. A machine readable storage, having stored thereon a computer program having a plurality of code sections for providing context information in a discussion forum, the machine readable storage comprising:
code for presenting a flat view comprising a plurality of posts of a discussion thread;
code for providing a control proximate to at least one of the plurality of posts, wherein each control is associated with the post proximate to that control; and
code for, responsive to activation of a control associated with a selected post, presenting hierarchy information relating to the discussion thread concurrently with the flat view, wherein context of the flat view is maintained.

16. The machine readable storage of claim 15, wherein the code for presenting hierarchy information further comprises code for displaying a portion of the discussion thread comprising the selected post, wherein a location of the selected post within a hierarchy of the discussion thread is indicated.

17. The machine readable storage of claim 16, further comprising code for, responsive to a selection of a post indicator within the portion of the discussion thread, presenting a post represented by the selected post indicator.

18. The machine readable storage of claim 15, wherein the code for presenting hierarchy information further comprises code for displaying indicators for the selected post, at least one parent post of the selected post, and at least one child post of the selected post, wherein each indicator is visually organized according to a hierarchy of the discussion thread.

19. The machine readable storage of claim 15, wherein the control comprises at least a first section and a second section and the first section of the control is activated, wherein the code for presenting hierarchy information further comprises code for displaying indicators for the selected post and only posts above the selected post according to a hierarchy of the discussion thread, wherein each indicator displayed is visually organized according to the hierarchy of the discussion thread.

20. The machine readable storage of claim 15, wherein the control comprises at least a first section and a second section and the second section of the control is activated, wherein the code for presenting a hierarchical view further comprises code for displaying indicators for the selected post and only posts below the selected post according to a hierarchy of the discussion thread, wherein each indicator displayed is visually organized according to the hierarchy of the discussion thread.
